(19) United States
(12) Patent Application Publication
(10) Pub. No.: US 2021/0317294 A1
(43) Pub. Date: Oct. 14, 2021

(54) Styrenic Polymers Derived from Depolymerised Polystyrene for Use in the Production of Foam Materials and as Melt Flow Modifiers

(71) Applicant: GreenMantra Recycling Technologies Ltd., Brantford (CA)

(72) Inventors: Domenic Di Mondo, Brantford (CA); Benjamin Scott, Brantford (CA)

(21) Appl. No.: 17/347,154

(22) Filed: Jun. 14, 2021

Related U.S. Application Data
(63) Continuation of application No. PCT/CA2019/051814, filed on Dec. 13, 2019.
(60) Provisional application No. 62/780,122, filed on Dec. 14, 2018.

(51) Int. Cl. C08L 25/06; C08J 11/04; C08J 9/36

(52) U.S. Cl. CPC C08L 25/06; C08J 11/04; C08L 2207/20; C08J 2205/10; C08J 2325/06; C08J 9/36

(57) ABSTRACT

A synthetic resin formulation can be made using a styrenic polymer created via the depolymerization of a polystyrene feedstock. In some embodiments the polystyrene feedstock contains recycled polystyrene foam. In some embodiments, the styrenic polymer has a molecular weight similar to virgin polystyrene. In some embodiments, the styrenic polymer has a higher molecular weight and reduces the amount of virgin polystyrene needed for a synthetic resin formulation. In some embodiments, the styrenic polymer has a lower molecular weight and increases the amount of recycled polystyrene that can be used in a synthetic resin formulation by increasing and homogenizing the melt flow of the recycled polystyrene. The synthetic resin formulation can be used to make expanded, extruded, and/or graphite polystyrene foam products, as well as rigid polystyrene and ABS products.

### CROSS-REFERENCE TO RELATED APPLICATIONS

This application is a continuation of International Application No. PCT/CA2019/051814 having an international filing date of Dec. 13, 2019 entitled “Styrenic Polymers Derived from Depolymerised Polystyrene for Use in the Production of Foam Materials and as Melt Flow Modifiers”. The '814 application is related to and claims priority benefit from U.S. Application Ser. No. 62/780,122 filed on Dec. 14, 2018 entitled, “Uses for Styrenic Polymers Derived from Depolymerized Polystyrene”.

The '814 and '122 applications are hereby incorporated by reference herein in their entireties.

### FIELD OF THE INVENTION

This invention relates to a method of producing foams or rigid polystyrene materials incorporating styrenic polymers synthesized via depolymerization of polystyrene. This invention also relates to the use of styrenic polymers synthesized via depolymerization of polystyrene as melt flow modifiers in polymer processing. Furthermore, polystyrene is non-biodegradable, leading to its accumulation in nature. Most of polystyrene waste is either land-filled or burnt. The former leads to the loss of material and waste of land, while the latter results in emission of green-house-gases. Only a small proportion of polystyrene waste is currently being recycled (at a rate of less than 5% in North America and Europe) as secondary polymers.

One batTier to using waste polystyrene as starting material to produce foamed polystyrene products is its broad specification nature. Specifically, the wide distribution of molecular weight and melt flow properties of waste polystyrene prevents or limits its ability to be incorporated into materials including extruded and expanded polystyrene foam products. Previous attempts to recycle waste polystyrene into new foam formulations, show incorporation of waste polystyrene is limited to approximately 15% of the total weight of the foam formulation. Incorporation at greater than 15% compromises properties of the final foam product such as cell structure and compression strength.

For example, some fractions of styrenic polymers produced via depolymerization of polystyrene often contain specific structural or chemical properties, including but not limited to, olefin content or longer aliphatic sections near terminal positions of the chain, narrower molecular weight distribution, higher melt flow- and/or uniform melt flow rate. Additionally, high molecular weight fractions of styrenic polymers produced via the depolymerization of polystyrene have a molecular weight distribution similar to virgin polystyrene which is traditionally used in the production of extruded and expanded polystyrene foam.

The uniform nature, that is, the narrowed distribution of molecular weight and melt flow, of styrenic polymers produced via the depolymerization of polystyrene feedstock makes them suitable for use in foam formulations that can be used in various applications including, but not limited to, extruded polystyrene (XPS) insulation foam board, XPS containers, XPS packing and packaging materials, expanded polystyrene (EPS) packing and packaging materials, and injection molded or extruded acrylonitrile butadiene styrene (ABS).

Incorporation of styrenic polymers created via depolymerization of polystyrene into the manufacture of foam products can reduce the amount of virgin polystyrene required to make the polystyrene foam materials, and ultimately help reduce greenhouse gases, landfill waste, and the need to produce styrenic foam products derived entirely from fossil or virgin polystyrene.

### SUMMARY OF THE INVENTION

In some embodiments a synthetic resin formulation can include a styrenic polymer created via depolymerization of a polystyrene feedstock made from recycled polystyrene and/or virgin polystyrene. In some embodiments, the recycled polystyrene is a polystyrene foam.

In some embodiments, the styrenic polymer has a molecular weight similar to that of virgin polystyrene.

In some embodiments, the styrenic polymer has a molecular weight between and inclusive of 5,000-230,000 amu. In some preferred embodiments the molecular weight is between, and inclusive of, 20,000 and 170,000 amu. In some more preferred embodiments, the molecular weight is between, and inclusive of, 35,000 and 130,000 amu. In some most preferred embodiments, the molecular weight is between, and inclusive of, 45,000 and 95,000 amu.

In some embodiments, the styrenic polymer has a melt flow index between, and inclusive of, 1-1000 g/10 min. In some preferred embodiments, the styrenic polymer has a melt flow index between, and inclusive of, 50-750 g/10 min. In some preferred embodiments, the styrenic polymer has a melt flow index between, and inclusive of, 75-650 g/10 min. In some preferred embodiments, the styrenic polymer has a melt flow index between, and inclusive of, 100-550 g/10 min. In some preferred embodiments, the styrenic polymer has a melt flow index between, and inclusive of, 110-500 g/10 min.

In some embodiments, the styrenic polymer can reduce the amount of virgin polystyrene needed for a synthetic resin formulation. In some embodiments, the styrenic resin can also include virgin polystyrene. In some embodiments, the styrenic polymer is at least 20% by weight of the synthetic resin formulation.

In some embodiments, the styrenic polymer has a molecular weight between, and inclusive of, 10,000-150,000 amu and a melt flow index between, and inclusive of, 14-750 g/min.

In some embodiments, the styrenic polymer can increase the amount of recycled polystyrene that can be used in a synthetic resin formulation by increasing and homogenizing the melt flow of the recycled polystyrene. In some embodiments, the styrenic polymer is 0.5-20% by weight of the synthetic resin formulation.

In some embodiments, the styrenic polymer can decrease the density of resin formulation for a foam product, reducing the overall weight of the product compared to resin formulations that do not incorporate the styrenic polymer.

In some embodiments, the styrenic polymer can decrease the extruder torque and die pressure thereby increasing the achievable throughput of foam product compared to resin formulations that do not incorporate the styrenic polymer.

Various embodiments of the synthetic resin formulation can be used to make expanded, extruded, and/or graphite polystyrene foam products. In certain embodiments, the extruded polystyrene foam product is insulation or packing material. In certain embodiments, the expanded polystyrene foam product is concrete.

In some embodiments, the synthetic resin formulation can be used to make rigid polystyrene products such as containers.

In some embodiments, the synthetic resin formulation can be used to make injection molded or extruded ABS parts such as automotive trim components.

### BRIEF DESCRIPTION OF THE DRAWINGS

FIG. 1 is a flowchart illustrating a process for treating polystyrene material to create styrenic polymers.

FIG. 2 is a flowchart illustrating a process for using styrenic polymers to create foam formulations.

FIG. 3 is a graph illustrating the heat flow of a high molecular weight fraction of styrenic polymer, POLYMER A made from depolymerization of waste polystyrene foam.

FIG. 4 is a graph illustrating the heat flow of a low molecular weight fraction of styrenic polymer, POLYMER B made from depolymerization of waste polystyrene foam.

FIG. 5 is a graph illustrating the heat flow of a low molecular weight fraction of styrenic polymer, POLYMER C made from depolymerization of waste polystyrene foam.

FIG. 6 is a graph illustrating the heat flow of a low molecular weight fraction of styrenic polymer, POLYMER D made from depolymerization of waste polystyrene foam.

FIG. 7A is a photograph of extruded polystyrene containing 99.5% virgin polystyrene/0.5% Talc.

FIG. 7B is a photograph of extruded polystyrene containing 74.5% virgin polystyrene/25% Recycled Polystyrene/0.5% Talc.

FIG. 7C is a photograph of extruded polystyrene containing 72.5% virgin polystyrene/25% Recycled Polystyrene/0.5% Talc with 2% styrenic polymer created via depolymerization of waste polystyrene.

FIG. 7D is a photograph of extruded polystyrene containing 70.5% virgin polystyrene/25% Recycled Polystyrene/0.5% Talc with 4% styrenic polymer created via depolymerization of waste polystyrene.

FIG. 7E is a photograph of extruded polystyrene containing 68.5% virgin polystyrene/25% Recycled Polystyrene/0.5% Talc with 6% styrenic polymer created via depolymerization of waste polystyrene.

FIG. 7F is a photograph of extruded polystyrene containing 64.5% virgin polystyrene/25% Recycled Polystyrene/0.5% Talc with 10% styrenic polymer created via depolymerization of waste polystyrene.

FIG. 8A is a Scanning Electron Microscope image of extruded polystyrene made from virgin polystyrene with 0% styrenic polymer produced from waste polystyrene present

FIG. 8B is a Scanning Electron Microscope image of extruded polystyrene made from virgin polystyrene with 2% styrenic polymer produced from waste polystyrene present

FIG. 8C is a Scanning Electron Microscope image of extruded polystyrene made from virgin polystyrene with 4% styrenic polymer produced from waste polystyrene present

FIG. 8D is a Scanning Electron Microscope image extruded polystyrene made from virgin polystyrene with 6% styrenic polymer produced from waste polystyrene present

FIG. 8E is a Scanning Electron Microscope image extruded polystyrene made from virgin polystyrene with 10% styrenic polymer produced from waste polystyrene present

FIG. 9 is a graph illustrating the effect of a styrenic polymer on the melt flow of virgin and recycled polystyrene feedstock.

FIG. 10 is a graph illustrating the effect of a styrenic polymer on the melt flow of different recycled polystyrene feedstocks.

FIG. 11 is a graph illustrating the effect of a styrenic polymer on the melt flow of virgin Acrylonitrile Butadiene Styrene (ABS) feedstock.

### DETAILED DESCRIPTION OF ILLUSTRATIVE EMBODIMENT(S)

A process for converting polystyrene feedstock to styrenic polymer and applications thereof were discussed in International Application PCT/CA2017/051166 entitled, “Reactor for Treating Polystyrene Material” and U.S. Application No. 62/678,780 entitled, “Uses of Styrenic Polymers Derived Through Depolymerized Polystyrene” which are hereby incorporated by reference in their entireties.

The present disclosure, teaches, among other things, a method for producing foam resin formulations using styrenic polymers.

In some embodiments of the method for producing foam resin formulations using styrenic polymers, the polystyrene material is recycled. Converting the polystyrene material into the styrenic polymers can include selecting a solid polystyrene material; heating the solid polystyrene material in an extruder to create a molten polystyrene material; filtering the molten polystyrene material; placing the molten polystyrene material through a chemical depolymerization process in a reactor to create styrenic polymer(s); cooling the styrenic polymer; and/or purifying the styrenic polymer(s).

In some embodiments the styrenic polymers can be modified to add additional active sites such as acrylates, ketones, esters, aldehydes, carboxylic acids, alcohols, and amines. The active sites can serve functionalization purposes. In some embodiments, to improve compatibility and/or add function, various monomers and/or copolymers such as, but not limited to, acids, alcohols, acetates, acrylates, ketones, esters, aldehydes, amines, and alkenes such as hexene can be grafted onto the depolymerized product.

In some embodiments, to improve compatibility and/or add function, the various monomers and/or copolymers are grafted on via the olefin fingerprint and/or via the aromatic functionality. Grafting can take place, among other places, in a reactor, in line with the stream after cooling, and/or in a separate vessel.

In some embodiments, the polystyrene material can be dissolved in certain solvents prior to depolymerization to adjust the viscosity of the polymer at various temperatures. In some embodiments, organic solvents, such as toluene, xylenes, cymenes, or terpinenes, are used to dissolve the polystyrene before it undergoes depolymerization within the reactor bed/vessel. In certain embodiments, the desired product can be isolated via separation or extraction and the solvent can be recycled.

In at least some embodiments, solvents are not required.

In certain embodiments, the solid polystyrene material is a recycled polystyrene. In some embodiments, the recycled polystyrene is a pellet made from recycled polystyrene foam and/or rigid polystyrene. Suitable waste polystyrene material includes, but is not limited to, mixed polystyrene waste such as expanded, and/or extruded polystyrene foam, and/or rigid products such as foam food containers, or packaging products. The mixed polystyrene waste can include various melt flows and molecular weights. In some embodiments, the waste polystyrene material feed includes up to 25% of material other than polystyrene material, based on the total weight of the waste polystyrene material feed.

In some embodiments, virgin polystyrene can also be used as a feedstock.

In some embodiments, the polymeric feed material is one of, or a combination of, virgin polystyrene and/or any one of, or combinations of post-industrial and/or post-consumer waste polystyrene.

In some embodiments, it is desirable to convert the polymeric feed material into lower molecular weight polymers, with increased melt flow and olefin content. In some embodiments, the conversion is affected by heating the polystyrene feed material to generate molten polystyrene material, and then contacting the molten polystyrene material with a catalyst material within a reaction zone disposed at a temperature between, and inclusive of, 200° C. and 400° C., preferable between, and inclusive of, 225° C.-375° C. In some embodiments, a catalyst is not required.

The molecular weight, polydispersity, glass transition, melt flow, and/or olefin content that is generated via the depolymerization depends on the residence time of the polystyrene material within the reaction zone.

In some embodiments the depolymerization process utilizes a catalyst such as [Fe—Cu—Mo—P]/Al₂O₃, zeolite, or other alumina supported systems, and/or thermal depolymerization. In some embodiments, the catalyst can be contained in a permeable container. In some embodiments, the catalyst can contain, iron, copper, molybdenum, phosphorous, and/or alumina.

In some embodiments, the purification of styrenic polymers utilizes flash separation, absorbent beds, clay polishing and/or film evaporators.

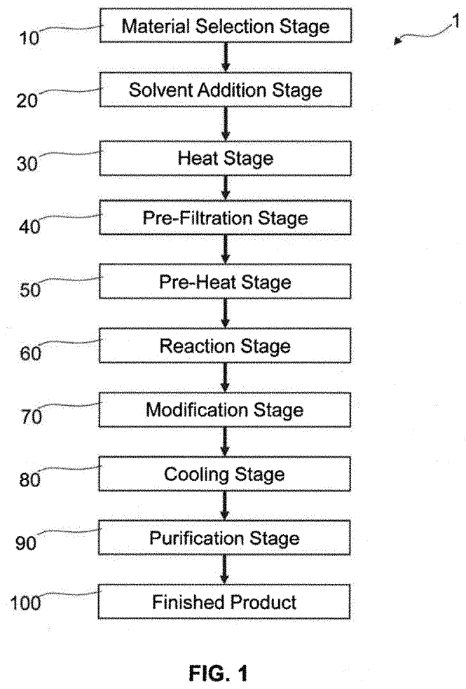

FIG. 1 illustrates Process 1 for treating polystyrene material. Process 1 can be run in batches or a continuous process. The parameters of Process 1, including but not limited to temperature, flow rate of polystyrene, monomers/copolymers grafted during the reaction and/or modification stages, and/or total number of pre-heat, reaction, or cooling segments, can be modified to create styrenic polymers of varying molecular weights between, and inclusive of, 5,000-230,000 amu. In some particular embodiments, such as when the resulting styrenic polymer is intended for use in foam formulations, the styrenic polymer can have varying molecular weights between, and inclusive of, 40,000-200,000 amu.

In some embodiments, in Material Selection Stage 10, polystyrene feed is sorted/selected and/or prepared for treatment. In some embodiments, the feed can contain up to 25% polyolefins PP, PE, PET, EVA, EVOH, and lower levels of undesirable additives or polymers, such as nylon, rubber, PVC, ash, filler, pigments, stabilizers, grit and/or other unknown particles.

In some embodiments, the polystyrene feed has an average molecular weight between, and inclusive of, 150,000-500,000 amu. In some embodiments, the polystyrene feed has an average molecular weight between, and inclusive of, 200,000-300,000 amu.

In some embodiments, the material selected in Material Selection Stage 10 comprises recycled polystyrene. In other or the same embodiments, the material selected in Material Selection Stage 10 comprises recycled polystyrene and/or virgin polystyrene.

In some embodiments, the material selected in Material Selection Stage 10 comprises waste polystyrene foam.

In some embodiments, in Solvent Addition Stage 20, solvents, such as toluene, xylenes, cymenes, or terpinenes, are used to dissolve the polystyrene before it undergoes depolymerization within the reactor bed/vessels. In certain embodiments, the desired product can be isolated via separation or extraction and the solvent can be recycled.

In some embodiments, the material selected in Material Selection Stage 10 can be heated in Heat Stage 30 in an extruder and undergoes Pre-Filtration Process 40. In some embodiments, the extruder is used to increase the temperature and/or pressure of the incoming polystyrene and is used to control the flow rates of the polystyrene. In some embodiments, the extruder is complimented by or replaced entirely by a pump/heater exchanger combination.

In some embodiments, the molten polystyrene material is derived from a polystyrene material feed that is heated to effect generation of the molten polystyrene material. In some embodiments, the polystyrene material feed includes primary virgin granules of polystyrene. The virgin granules can include various molecular weights and melt flows.

In some embodiments, Pre-Filtration Process 40 can employ both screen changers and filter beds, along with other filtering techniques/devices to remove contaminants from and purify the heated material. In some embodiments, the resulting filtered material is then moved into an optional Pre-Heat Stage 50 which brings the filtered material to a higher temperature before it enters Reaction Stage 60. In some embodiments, Pre-Heat Stage 50 can employ, among other devices and techniques, static and/or dynamic mixers and heat exchangers such as internal fins and heat pipes.

In some embodiments, material in Reaction Stage 60 undergoes depolymerization. This depolymerization can be a purely thermal reaction and/or it can employ catalysts. Depending on the starting material and the desired styrenic polymer, depolymerization can be used for a slight or extreme reduction of the molecular weight of the starting material. In some embodiments, the catalyst used is a zeolite or alumina supported system or a combination of the two. In some embodiments, the catalyst is [Fe—Cu—Mo—P]/Al₂O₃ prepared by binding a ferrous-copper complex to an alumina or zeolite support and reacting it with an acid comprising metals and non-metals to obtain the catalyst material. Other suitable catalyst materials include zeolite, mesoporous silica, H-mordenite and alumina. The system can also be run in the absence of a catalyst and produce lower molecular weight polymer through thermal degradation.

In some embodiments, the depolymerization of the polymeric material is a catalytic process, a thermal process, utilizes free radical initiators, and/or utilizes radiation.

In some embodiments, Reaction Stage 60 can employ a variety of techniques/devices including, among other things, fixed beds, horizontal and/or vertical reactors, and/or static mixers. In some embodiments, Reaction Stage 60 employs multiple reactors and/or reactors divided into multiple sections.

In some embodiments, after Reaction Stage 60 the depolymerized material enters optional Modification Stage 70. In at least some embodiments, Modification Stage 70 involves grafting various monomers and/or copolymers such as, but not limited to, acids, alcohols, acetates, and/or alkenes such as hexene onto the depolymerized product.

In some embodiments, Cooling Stage 80 can employ heat exchangers, along with other techniques/devices to bring the styrenic polymer down to a workable temperature before it enters optional Purification Stage 90. In some embodiments, cleaning/purification of the styrenic polymers via such methods such as nitrogen stripping occurs before Cooling Stage 80.

Optional Purification Stage 90 involves the refinement and/or decontamination of the styrenic polymers. Techniques/devices that can used in Purification Stage 90 include, but are not limited to, flash separation, absorbent beds, clay polishing, distillation, vacuum distillation, and filtration to remove solvents, oils, color bodies, ash, inorganics, and coke. In some embodiments, a thin or wiped film evaporator is used to remove gas, oil and/or grease, and/or lower molecular weight functionalized polymers from the styrenic polymer. In some embodiments, the oil, gas, and lower molecular weight functionalized polymers can in turn be burned to help run various Stages of Process 1. In certain embodiments, the desired product can be isolated via separation or extraction and the solvent can be recycled.

Process 1 ends at Finished Product Stage 100 in which the initial starting material selected in Material Selection Stage 10 has been turned into styrenic polymers. In at least some embodiments, the styrenic polymers do not need additional processing and/or refining. In other embodiments, the styrenic polymers created at Finished Product Stage 100 need additional modifications.

In some embodiments, the generated depolymerization product material includes monomer (styrene), aromatic solvents, polyaromatic species, oils, and/or lower molecular weight functionalized polymers, such as those with increased olefin content.

In some embodiments, the styrenic polymer has an average molecular weight between, and inclusive of, 5,000-230,000 amu and a melt flow between, and inclusive of, 1-1000 g/10 min (determined via ASTM D1238). In some embodiments, the styrenic polymer has a glass transition temperature between, and inclusive of, 30-115° C.

In some embodiments, the styrenic polymer has a molecular weight between and inclusive of 5,000-230,000 amu. In some preferred embodiments the molecular weight is between, and inclusive of, 20,000 and 170,000 amu. In some more preferred embodiments, the molecular weight is between, and inclusive of, 35,000 and 130,000 amu. In some most preferred embodiments, the molecular weight is between, and inclusive of, 45,000 and 95,000 amu.

In some embodiments, the styrenic polymer has a melt flow index between, and inclusive of, 1-1000 g/10 min. In some preferred embodiments, the styrenic polymer has a melt flow index between, and inclusive of, 50-750 g/10 min. In some preferred embodiments, the styrenic polymer has a melt flow index between, and inclusive of, 75-650 g/10 min. In some preferred embodiments, the styrenic polymer has a melt flow index between, and inclusive of, 100-550 g/10 min. In some preferred embodiments, the styrenic polymer has a melt flow index between, and inclusive of, 110-500 g/10 min. In some embodiments, the resulting styrenic polymer can have a molecular weight range between, and inclusive of, 40,000-200,000 amu and a melt flow range between, and inclusive of, 1-750 g/10 min.

In some embodiments, the styrenic polymer has a viscosity between and inclusive of 100-150,000 cps measured at 250 C. In some preferred embodiments the viscosity is between 1,000 and 125,000 cps measured at 250 C. In other preferred embodiments the viscosity is between 5,000 and 100,000 cps measured at 250 C.

In some embodiments, the styrenic polymer has a viscosity between and inclusive of 1,000-150,000 cps measured at 225 C. In some preferred embodiments the viscosity is between 1,500 and 120,000 cps measured at 225 C. In other preferred embodiments, viscosity is between 2,000 and 100,000 cps measured at 225 C.

In some embodiments, the resulting styrenic polymer can have a melt flow range greater than 50 g/10 min. In some preferred embodiments, the resulting styrenic polymer can have a melt flow range between, and inclusive of, 50-500 g/10 min.

In some embodiments, the resulting styrenic polymer can be used to produce EPS, XPS, and/or graphite polystyrene (GPS) foam. The polystyrene foam can be used in various applications including, but not limited to, XPS insulation foam board, XPS containers, XPS packing and packaging materials, EPS packing and packaging materials, insulated concrete forms, interior decorative moldings, ceiling tiles, and other roof, wall, floor, below grade, and structural insulation applications.

Styrenic polymers derived from depolymerized polystyrene can be used to make polystyrene foam products. In some embodiments, this is due to the high molecular weight fraction of styrenic polymer having a more uniform distribution of molecular weight and melt flow properties compared to unmodified, that is, non-depolymerized waste polystyrene. In some embodiments, styrenic polymers derived from depolymerized polystyrene have properties comparable to virgin polystyrene including, but not limited to, molecular weight, molecular weight distribution (dispersity), and melt flow index.

In some embodiments, a higher percentage of styrenic polymer derived from depolymerization of waste polystyrene foam, compared to the percentage of unmodified waste polystyrene foam, can be used in foam resin formulations while maintaining the desired properties, such as density, cell structure and compression strength, of a final foam product.

In some embodiments, fractions of styrenic polymer derived from depolymerization of waste polystyrene foam can be used to increase and or homogenize the melt flow of recycled polystyrene feedstock which, in turn, increases the amount of recycled polystyrene that can be used in foam resin formulations.

In some embodiments, fractions of styrenic polymer derived from depolymerization of waste polystyrene foam can be used to decrease the density of the foam product

In some embodiments, fractions of styrenic polymer derived from depolymerization of waste polystyrene foam can be used to decrease the extruder torque and die pressure which, in turn, can increase throughput of foam product.

In some embodiments, the resulting styrenic polymer can be used to produce rigid polystyrene-based products including, but not limited to, coat hangers, lids, toys, home appliances, gardening pots, automotive parts, and containers.

In some embodiments, the synthetic resin formulation can be used to make injection molded or extruded ABS parts such as automotive trim components.

Various parameters of Process 1 including, but not limited to, temperature, pressure, flow rate of polystyrene, catalyst selection, monomers/copolymers grafted during the reaction and/or modification stages, and total number and/or run time of pre-heat, reaction, and/or cooling segments, can be modified to maximize the yield of styrenic polymer fractions that can be used in foam resin formulations.

In some embodiments, EPS and XPS foams can be produced using a styrenic polymer produced via depolymerization of virgin and/or recycled polystyrene. In some preferred embodiments, styrenic polymer used to make polystyrene foam can be produced via depolymerization of waste polystyrene foam.

In some embodiments, the parameters of Process 1 can be optimized to increase the compatibility of styrenic polymers for foam resin formulations such that a higher percentage of styrenic polymer can be used in the formulation. For example, various reaction conditions of Process 1 can be modified to produce styrenic polymers with the optimal or preferred molecular weight distribution and melt flow properties suitable for incorporation into foam resin formulations.

In some embodiments, styrenic polymers can be incorporated with virgin polystyrene and/or waste polystyrene foam to create foam products.

In some embodiments, lower molecular weight fractions of styrenic polymers, that is, styrenic polymers having molecular weights less than 100,000 amu and melt flows greater than 10 g/min, can be used as an additive to increase the amount of recycled polystyrene that can be used in a polystyrene synthetic resin formulations, foam formulations, or other extruded polystyrene products by increasing and homogenizing the variable, low melt flow of the incoming recycled polystyrene. In some embodiments, the lower molecular weight fractions of styrenic polymers can be 0.5-20% by weight of the formulation used to produce polystyrene foam or other extruded polystyrene products.

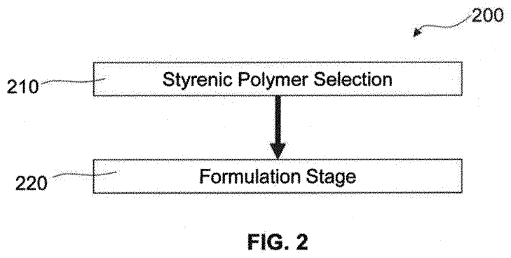

FIG. 2 shows Process 200 for using a styrenic polymer product created via a depolymerization process (such as the one described in FIG. 1) to create a foam resin formulation. First, a styrenic polymer product is chosen in Styrenic Polymer Selection Stage 210 and then added in Formulation Stage 220 to create a foam resin.

### Illustrative Examples

In illustrative embodiments of the discussed process, waste polystyrene foam was used to create a range of depolymerized styrenic polymers: Polymer A, Polymer B, Polymer C, and Polymer D.

Polymer A was a high molecular weight fraction of styrenic polymer product having a molecular weight distribution of 175,000-225,000 amu. Polymer B and Polymer C were lower molecular weight styrenic polymer products, having a molecular weight distribution of 50,000-75,000. Polymer D had a molecular weight of approximately 65,000.

The melt flow index and differential scanning calorimetry (DSC) values of Polymer A, Polymer B, Polymer C and Polymer D are outlined in Table 1.

TABLE 1
Properties of Depolymerized Styrenic Polymers

| Test | | POLYMER A | POLYMER B | POLYMER C | POLYMER D |
|---|---|---|---|---|---|
| MFI (g/10 min) | | 1.44 | >50 | >50 | >50 |
| DSC (° C.) | GTTᵢₙᵢₜᵢₐₗ | 95.6 | 73.9 | 67.1 | 40.9 |
| | GTT_{mid-point} | 102.8 | 78.7 | 78.4 | 61.0 |
| | GTT_{end} | 109.7 | 83.5 | 89.9 | 83.1 |

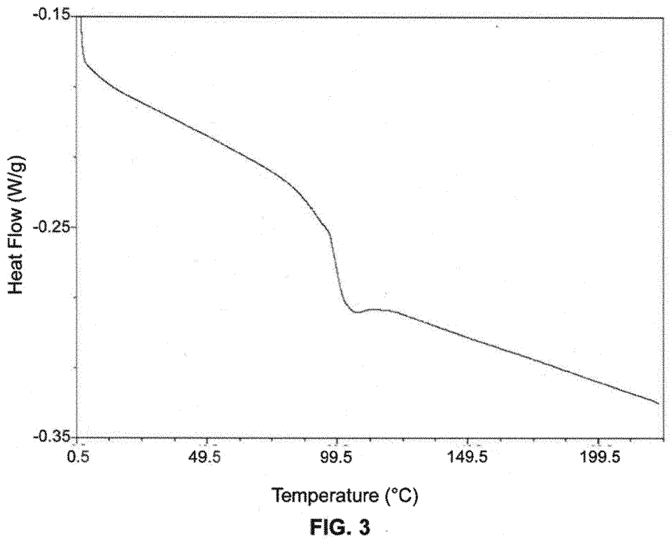

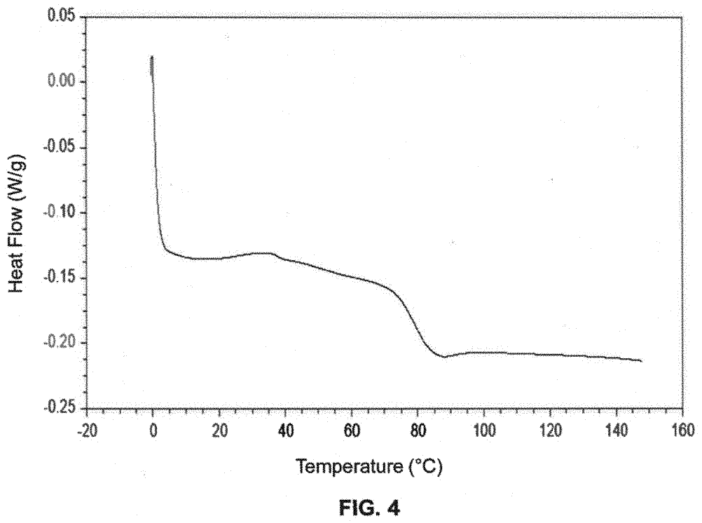

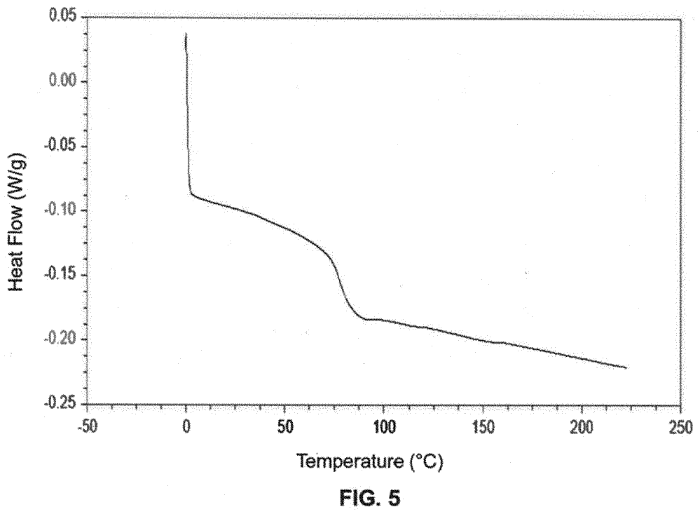

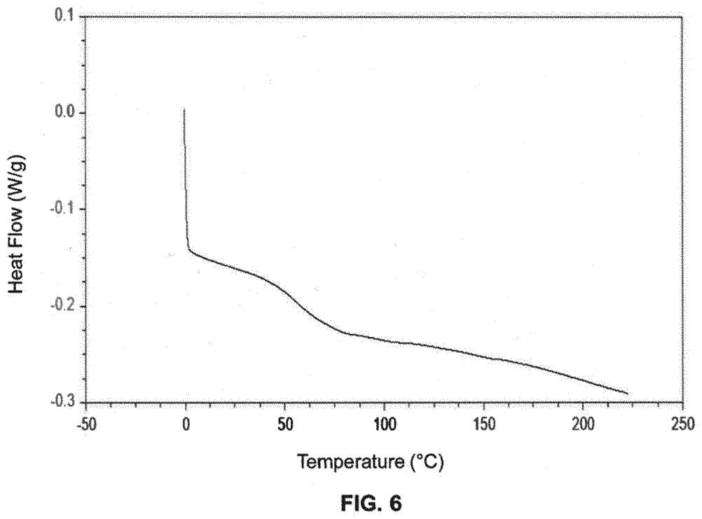

Heat flow data of Polymer A, Polymer B, Polymer C and Polymer D are depicted in the graphs of FIG. 3, FIG. 4, FIG. 5 and FIG. 6 respectively.

These exemplary depolymerized styrenic polymers were then mixed with other components (see Table 2, Table 3, Table 4 and Table 6) to create various formulations that were then tested to demonstrate various properties.

TABLE 2
Properties of Recycled PS

| | | RECYCLED | RECYCLED | RECYCLED | RECYCLED |
|---|---|---|---|---|---|
| Test | | PS-A | PS-B | PS-C | PS-D |
| MFI (g/10 min) | | 0.94 | 4.87 | 6.1 | 4.4 |
| DSC | GTTᵢₙᵢₜᵢₐₗ | 97.1 | 87.6 | 97.6 | 92.5 |
| (° C.) | GTT_{mid-point} | 106.0 | 96.1 | 103.4 | 96.5 |
| | GTT_{end} | 114.8 | 103.0 | 107.6 | 103.3 |

TABLE 3
Sample Components

| Ingredient | Grade/Type |
|---|---|
| AmSty EA3130 | Virgin General Purpose Polystyrene |
| Total 535B | Virgin General Purpose Polystyrene |
| Sigma PS | Virgin General Purpose Polystyrene |
| Ineos Terluran GP-22 | Virgin Acrylonitrile Butadiene Styrene |
| Polymer A | Depolymerized styrenic polymer |
| Polymer B | Depolymerized styrenic polymer |
| Polymer C | Depolymerized styrenic polymer |
| Polymer D | Depolymerized styrenic polymer |
| Recycled PS-A | Waste polystyrene foam |
| Recycled PS-B | Waste polystyrene |
| Recycled PS-C | Waste polystyrene |
| Recycled PS-D | Waste polystyrene |

### Example of Use of High Weight Styrenic Polymers to Create Foams

As set forth in Table 4, foam resin formulations prepared from polystyrene feedstock (Recycled PS-A) and styrenic polymer (Polymer A) were compared to a control foam resin formulation made with virgin polystyrene, EA3130, the traditional polystyrene starting material used in foam production.

An initial test was conducted on Formulations 1-3 (and Control I) to determine if a foam could be created using (at least a percentage) of depolymerized polystyrene.

To determine if foam production could be affected using polystyrene feedstock depolymerized to form styrenic polymers, Polymer A was compared to untreated waste polystyrene foam, Recycled PS-A, that had not undergone depolymerization Process 1. Recycled PS-A had a molecular weight distribution of approximately 225,000-250,000 amu.

Formulations 1-3 and Control I were mixed with 0.5 pph foaming agent FP-40 and underwent standard foam extrusion. Extruder conditions for each formulation are shown in Table 5.

Extruder conditions for Formulations 1 and 2 were within a suitable range compared to the Control I values and indicate that foam production using styrenic polymer does not require greater energy input nor does it increase equipment strain during extrusion. These data indicate that foam production using styrenic polymer can be carried out under existing manufacturing conditions and does not require retooling of production equipment.

TABLE 4
Composition of Foam Formulations

| | % of Total Weight | | | | | | | | | |
|---|---|---|---|---|---|---|---|---|---|---|
| | Polymer | Polymer | Polymer | | | Recycled | Recycled | HCFO- | | |
| | A | B | C | EA3130 | 535B | PS-A | PS-B | 1233zd | FP-40 | Talc |
| Control | 0 | 0 | 0 | 100 | 0 | 0 | 0 | 0 | 0.5 | 0 |
| I | | | | | | | | | | |
| 1 | 50 | 0 | 0 | 50 | 0 | 0 | 0 | 0 | 0.5 | 0 |
| 2 | 100 | 0 | 0 | 0 | 0 | 0 | 0 | 0 | 0.5 | 0 |
| 3 | 0 | 0 | 0 | 0 | 0 | 100 | 0 | 0 | 0.5 | 0 |
| 4 | 0 | 0 | 0 | 0 | 99.5 | 0 | 0 | 9.9 | 0 | 0.5 |
| 5 | 0 | 2 | 0 | 0 | 97.5 | 0 | 0 | 9.9 | 0 | 0.5 |
| 6 | 0 | 4 | 0 | 0 | 95.5 | 0 | 0 | 9.9 | 0 | 0.5 |
| 7 | 0 | 6 | 0 | 0 | 93.5 | 0 | 0 | 9.9 | 0 | 0.5 |
| 8 | 0 | 10 | 0 | 0 | 89.5 | 0 | 0 | 9.9 | 0 | 0.5 |
| 9 | 0 | 4 | 0 | 0 | 95.5 | 0 | 0 | 9.2 | 0 | 0.5 |
| 10 | 0 | 0 | 0 | 0 | 74.5 | 0 | 25 | 10.0 | 0 | 0.5 |
| 11 | 0 | 2 | 0 | 0 | 72.5 | 0 | 25 | 10.0 | 0 | 0.5 |
| 12 | 0 | 4 | 0 | 0 | 70.5 | 0 | 25 | 10.0 | 0 | 0.5 |
| 13 | 0 | 6 | 0 | 0 | 68.5 | 0 | 25 | 10.0 | 0 | 0.5 |
| 14 | 0 | 10 | 0 | 0 | 64.5 | 0 | 25 | 10.0 | 0 | 0.5 |
| 15 | 0 | 4 | 0 | 0 | 70.5 | 0 | 25 | 9.1 | 0 | 0.5 |
| 16 | 0 | 0 | 0 | 0 | 0 | 0 | 99.5 | 9.9 | 0 | 0.5 |
| 17 | 0 | 2 | 0 | 0 | 0 | 0 | 97.5 | 9.9 | 0 | 0.5 |
| 18 | 0 | 4 | 0 | 0 | 0 | 0 | 95.5 | 9.9 | 0 | 0.5 |
| 19 | 0 | 6 | 0 | 0 | 0 | 0 | 93.5 | 10.0 | 0 | 0.5 |
| 20 | 0 | 10 | 0 | 0 | 0 | 0 | 89.5 | 9.8 | 0 | 0.5 |
| 21 | 0 | 0 | 0 | 0 | 99.5 | 0 | 0 | 14.67 | 0 | 0.5 |
| 22 | 0 | 0 | 5 | 0 | 94.5 | 0 | 0 | 14.67 | 0 | 0.5 |
| 23 | 0 | 0 | 5 | 0 | 94.5 | 0 | 0 | 14.67 | 0 | 0.5 |
| 24 | 0 | 0 | 0 | 0 | 99.5 | 0 | 0 | 12.00 | 0 | 0.5 |
| 25 | 0 | 0 | 3 | 0 | 96.5 | 0 | 0 | 12.00 | 0 | 0.5 |
| 26 | 0 | 0 | 0 | 0 | 99.5 | 0 | 0 | 9.93 | 0 | 0.5 |
| 27 | 0 | 0 | 3 | 0 | 96.5 | 0 | 0 | 9.93 | 0 | 0.5 |
| 28 | 0 | 0 | 5 | 0 | 94.5 | 0 | 0 | 9.93 | 0 | 0.5 |
| 29 | 0 | 0 | 0 | 0 | 99.5 | 0 | 0 | 10.92 | 0 | 0.5 |
| 30 | 0 | 0 | 3 | 0 | 96.5 | 0 | 0 | 10.92 | 0 | 0.5 |
| 31 | 0 | 0 | 0 | 0 | 89.5 | 0 | 10 | 9.90 | 0 | 0.5 |
| 32 | 0 | 0 | 3 | 0 | 86.5 | 0 | 10 | 9.90 | 0 | 0.5 |
| 33 | 0 | 0 | 5 | 0 | 84.5 | 0 | 10 | 9.90 | 0 | 0.5 |
| 34 | 0 | 0 | 5 | 0 | 74.5 | 0 | 25 | 9.90 | 0 | 0.5 |
| 35 | 0 | 0 | 3 | 0 | 76.5 | 0 | 25 | 9.90 | 0 | 0.5 |
| 36 | 0 | 0 | 0 | 0 | 79.5 | 0 | 20 | 9.90 | 0 | 0.5 |
| 37 | 0 | 0 | 5 | 0 | 84.5 | 0 | 10 | 9.90 | 0 | 0.5 |
| 38 | 0 | 0 | 5 | 0 | 64.5 | 0 | 30 | 9.90 | 0 | 0.5 |
| 39 | 0 | 0 | 0 | 0 | 69.5 | 0 | 30 | 9.90 | 0 | 0.5 |
| 40 | 0 | 0 | 3 | 0 | 96.5 | 0 | 0 | 10.00 | 0 | 0.5 |
| 41 | 0 | 0 | 3 | 0 | 96.5 | 0 | 0 | 10.00 | 0 | 0.5 |
| 42 | 0 | 0 | 3 | 0 | 96.5 | 0 | 0 | 10.00 | 0 | 0.5 |
| 43 | 0 | 0 | 5 | 0 | 94.5 | 0 | 0 | 10.00 | 0 | 0.5 |
| 44 | 0 | 0 | 5 | 0 | 94.5 | 0 | 0 | 10.00 | 0 | 0.5 |
| 45 | 0 | 0 | 5 | 0 | 94.5 | 0 | 0 | 10.00 | 0 | 0.5 |
| 46 | 0 | 0 | 20 | 0 | 79.5 | 0 | 0 | 10.00 | 0 | 0.5 |
| 47 | 0 | 0 | 20 | 0 | 79.5 | 0 | 0 | 10.00 | 0 | 0.5 |
| 48 | 0 | 0 | 20 | 0 | 79.5 | 0 | 0 | 10.00 | 0 | 0.5 |
| 49 | 0 | 0 | 0 | 0 | 99.5 | 0 | 0 | 10.13 | 0 | 0.5 |
| 50 | 0 | 0 | 0 | 0 | 99.5 | 0 | 0 | 10.13 | 0 | 0.5 |
| 51 | 0 | 0 | 0 | 0 | 99.5 | 0 | 0 | 10.13 | 0 | 0.5 |
| 52 | 0 | 0 | 5 | 0 | 94.5 | 0 | 0 | 10.13 | 0 | 0.5 |
| 53 | 0 | 0 | 5 | 0 | 94.5 | 0 | 0 | 10.13 | 0 | 0.5 |
| 54 | 0 | 0 | 5 | 0 | 94.5 | 0 | 0 | 10.16 | 0 | 0.5 |
| 55 | 0 | 0 | 5 | 0 | 94.5 | 0 | 0 | 10.16 | 0 | 0.5 |
| 56 | 0 | 0 | 0 | 0 | 99.5 | 0 | 0 | 10.16 | 0 | 0.5 |
| 57 | 0 | 0 | 0 | 0 | 99.5 | 0 | 0 | 10.16 | 0 | 0.5 |

TABLE 5
Extruder Conditions During Foam Production

| | % | | | | Density |
|---|---|---|---|---|---|
| | Depolymerized | Extruder Conditions | | | of |
| | Styrenic | Feed Rate/ | Torque/ | Die | Foam/ |
| Blend # | Polymer | kg/h | % | Pressure/psi | kg/m³ |
| Control I | 0 | NR | 63 | 145 | NR |
| 1 | 50 | NR | 53-63 | 145 | NR |
| 2 | 100 | NR | 43-65 | 116 | NR |
| 3 | 0 | NR | 43-60 | 203 | NR |
| 4 | 0 | 16.49 | 40-41 | NR | 54.0 |
| 5 | 2 | 16.49 | 40 | 480 | 51.8 |
| 6 | 4 | 16.49 | 37-40 | 470 | 50.0 |
| 7 | 6 | 16.49 | 36-37 | 450 | 50.8 |
| 8 | 10 | 16.49 | 33-36 | 390 | 49.3 |
| 9 | 4 | 16.38 | 37-39 | NR | 54.0 |
| 10 | 0 | 16.50 | 40-41 | 500 | 52.0 |
| 11 | 2 | 16.50 | 38-40 | 430 | 49.3 |
| 12 | 4 | 16.50 | 37-38 | 410 | 50.0 |
| 13 | 6 | 16.50 | 35-36 | 400 | 50.0 |
| 14 | 10 | 16.50 | 34-35 | 330 | 49.7 |
| 15 | 4 | 16.37 | 38-39 | 550 | 55.8 |
| 16 | 0 | 16.49 | 35 | 390 | 51.2 |
| 17 | 2 | 16.49 | 34-35 | 370 | 47.8 |
| 18 | 4 | 16.49 | 32-33 | 330 | 53.6 |
| 19 | 6 | 16.49 | 31 | 320 | 52.0 |
| 20 | 10 | 16.48 | 31-32 | 220 | 50.7 |
| 21 | 0 | 22.93 | 38 | 600 | 38.5 |
| 22 | 5 | 22.93 | 35-36 | 610 | 37.0 |
| 23 | 5 | 22.93 | 35-36 | 610 | 37.0 |
| 24 | 0 | 22.40 | 39-40 | 680 | 41.0 |
| 25 | 3 | 22.40 | 38 | 640 | 41.5 |
| 26 | 0 | 21.99 | 43-45 | 890 | 50.0 |
| 27 | 3 | 21.99 | 40-41 | 850 | 48.3 |
| 28 | 5 | 21.99 | 38-39 | 850 | 49.5 |
| 29 | 0 | 22.18 | 40-41 | 760 | 44.8 |
| 30 | 3 | 22.18 | 38-40 | 800 | 46.0 |
| 31 | 0 | 21.98 | 42-44 | 740 | 48.0 |
| 32 | 3 | 21.98 | 41-42 | 870 | 48.0 |
| 33 | 5 | 21.98 | 37-40 | 670 | 41.8 |
| 34 | 5 | 21.98 | 39-40 | 880 | 50.5 |
| 35 | 3 | 21.98 | 41 | 870 | 51.5 |
| 36 | 0 | 21.98 | 41-42 | 950 | 51.5 |
| 37 | 5 | 21.98 | 38-40 | 870 | 50.0 |
| 38 | 5 | 21.98 | 38-39 | 850 | 51.0 |
| 39 | 0 | 21.98 | 41-42 | 850 | 51.0 |
| 40 | 3 | 16.50 | 36-38 | 770 | 51.0 |
| 41 | 3 | 16.50 | 36-38 | 770 | 51.5 |
| 42 | 3 | 16.50 | 35-36 | 800 | 49.0 |
| 43 | 5 | 16.50 | 33-35 | 800 | 50.8 |
| 44 | 5 | 16.50 | 36 | 810 | 50.5 |
| 45 | 5 | 16.50 | 34-35 | 810 | 51.0 |
| 46 | 20 | 16.50 | 28-31 | 680 | 54.0 |
| 47 | 20 | 16.50 | 30 | 620 | 51.5 |
| 48 | 20 | 16.50 | 30 | 620 | 52.0 |
| 49 | 0 | 27.53 | 48-49 | 1010 | 49.0 |
| 50 | 0 | 27.53 | 47-50 | 980 | 48.5 |
| 51 | 0 | 27.53 | 47-50 | 1010 | 48.0 |
| 52 | 5 | 27.53 | 44-46 | 920 | 50.5 |
| 53 | 5 | 27.53 | 45 | 900 | 47.5 |
| 54 | 5 | 30.84 | 47-50 | 1040 | 49.5 |
| 55 | 5 | 30.84 | 48-50 | 1040 | 49.5 |
| 56 | 0 | 30.84 | 51-53 | 1080 | 47.5 |
| 57 | 0 | 30.84 | 52-54 | 1080 | 49.0 |

Resin foam formulations were also formed into pellets. Successful foam generation for each resin formulation was determined by the ability of each resulting pellet to float in water (Table 6) as this represents the proper transition of polystyrene in non-foam form, which is denser than water, to polystyrene foam, which is less dense than water.

TABLE 6
Density Observations of Resin Formulations

| | Formulation | | | |
|---|---|---|---|---|
| Property | Control I | 1 | 2 | 3 |
| Buoyancy | Float | Float | 75% Sink | Sink |

As indicated in Table 6, resin formed from 100% waste polystyrene foam (Formulation 3) produced pellets that sunk, indicating functional foam composition was not achieved.

Resin formed from 100% styrenic polymer (Formulation 2) produced pellets that sunk (3 of 4 replicates) and floated (1 of 4 replicates). This result suggests that using 100%, or at least greater than 50%, styrenic polymer derived from depolymerization of waste polystyrene can be feasible for production of foam materials.

Resin formed from 50% virgin polystyrene and 50% Polymer A (Formulation 1) produced pellets that floated, indicating functional foam composition was achieved.

This data also supports that, in at least some embodiments, the styrenic polymers derived from depolymerization also enable lower densities of final foam products, leading to greater buoyancy.

Previous attempts to create a foam using 50% virgin polystyrene and 50% recycled polystyrene foam had been unsuccessful. The ability of Formulation 1, a 50% virgin polystyrene and 50% Polymer A composition, to produce a functional foam material indicates styrenic polymers derived from depolymerization of waste polystyrene have unique properties that are advantageous for use in foam production and that such properties are lacking in unmodified, that is, non-depolymerized waste polystyrene foam.

### Example of Use of Low Weight Styrenic Polymers to Create Foams

Foam trials were also completed in which the lower molecular weight styrenic polymers derived from depolymerization of waste polystyrene, Polymer B and Polymer C were used as an additive at lower concentrations within the overall formulation.

As set forth in Table 4, foam resin formulations prepared from Recycled PS-B and styrenic polymers (Polymer B and Polymer C) were compared to control foam resin formulations made with virgin polystyrene, 535B, a traditional polystyrene starting material used in foam production.

Formulations 4-57 were mixed with foaming agent HCFO-1233zd(E) and underwent standard foam extrusion. Formulations 4-57 employed 0.5% talc as a nucleating agent (via a 20% masterbatch). All of Formulations 4-57 resulted in a successful foam product.

Extruder conditions and key properties (density of foam and feed rate) for each formulation are shown in Table 5.

Extruder conditions for formulations containing Polymer B or Polymer C resulted in a reduced die pressure extruder torque. These values are within a suitable range compared to the control formulation values and indicate that foam production using styrenic polymer requires less energy input and decreases equipment strain during extrusion.

The reduction in extruder torque and die pressure indicates that polymers derived from depolymerization of waste polystyrene can allow for increased throughput of XPS foam production.

These data indicate that foam production using styrenic polymer can be carried out under existing manufacturing conditions and does not require retooling of production equipment.

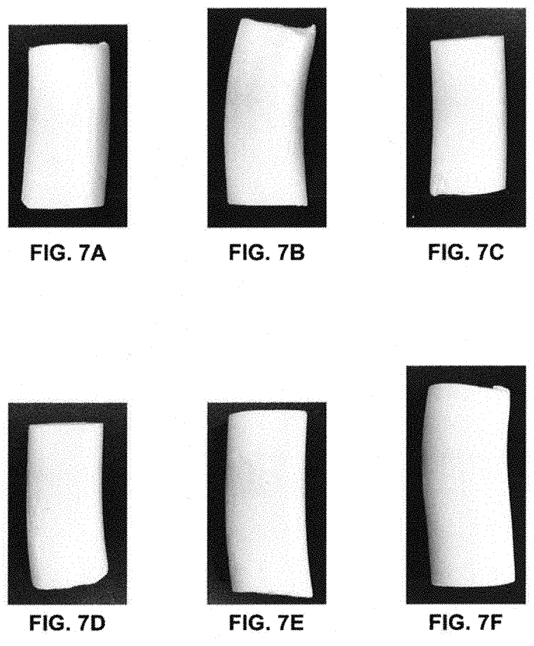

FIG. 7A is a photograph illustrating the resulting foam made from virgin polystyrene with 0% styrenic polymer produced from waste polystyrene present (Formulation 4).

FIG. 7B is a photograph illustrating the resulting foam made from virgin polystyrene and recycled polystyrene with 0% styrenic polymer produced from waste polystyrene present (Formulation 10).

FIG. 7C is a photograph illustrating the resulting foam made from virgin polystyrene and recycled polystyrene with 2% styrenic polymer produced from waste polystyrene present (Formulation 11).

FIG. 7D is a photograph illustrating the resulting foam made from virgin polystyrene and recycled polystyrene with 4% styrenic polymer produced from waste polystyrene present (Formulation 12).

FIG. 7E is a photograph illustrating the resulting foam made from virgin polystyrene and recycled polystyrene with 6% styrenic polymer produced from waste polystyrene present (Formulation 13).

FIG. 7F is a photograph illustrating the resulting foam made from virgin polystyrene and recycled polystyrene with 10% styrenic polymer produced from waste polystyrene present (Formulation 14).

As can be seen from Table 7 the densities of foams produced containing Polymer B or Polymer C were typically lower compared to the controls.

Samples of the resin foam formulations were taken and scanning electron microscopy images were captured to measure foam integrity and open cell content. The integrity of the foam and the open cell content of the foam was not adversely affected by the inclusion of styrenic polymer derived from depolymerization of waste polystyrene

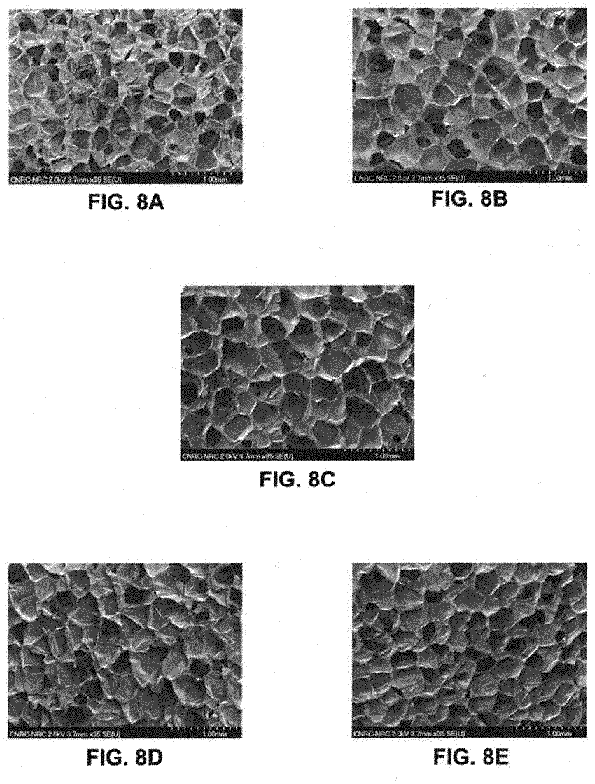

FIG. 8A is a scanning electron micrograph illustrating the resulting foam made from virgin polystyrene with 0% styrenic polymer produced from waste polystyrene present (Formulation 4).

FIG. 8B is a scanning electron micrograph illustrating the resulting foam made from virgin polystyrene with 2% styrenic polymer produced from waste polystyrene present (Formulation 5).

FIG. 8C is a scanning electron micrograph illustrating the resulting foam made from virgin polystyrene with 4% styrenic polymer produced from waste polystyrene present (Formulation 6).

FIG. 8D is a scanning electron micrograph illustrating the resulting foam made from virgin polystyrene with 6% styrenic polymer produced from waste polystyrene present (Formulation 7).

FIG. 8E is a scanning electron micrograph illustrating the resulting foam made from virgin polystyrene with 10% styrenic polymer produced from waste polystyrene present (Formulation 8).

This data indicates that styrenic polymers derived from depolymerization of waste polystyrene have unique properties that are advantageous for use in foam production. Such properties include density modifiers and throughput modifiers.

### Example of Styrenic Polymers as Melt Flow Modifiers

To determine if low molecular weight fractions of styrenic polymers can be used to increase the melt flow of virgin or recycled polystyrene feedstock, styrenic polymer Polymer C or Polymer D having a molecular weight of approximately 65,000 amu were added to virgin or recycled polystyrene feedstock as set forth in Table 7. The melt flow of each styrenic polymer-polystyrene resin blend was subsequently tested and compared to untreated virgin or recycled polystyrene (PS) feedstock. The resulting melt flow index of each blend are also outlined in Table 7.

TABLE 7
Composition of Resin Formulations and Resulting Melt Flow Indexes

| | % of Total Weight | | | | | | | MFI @ | % |
|---|---|---|---|---|---|---|---|---|---|
| | Polymer | Polymer | Sigma | GP-22 | Recycled | Recycled | Recycled | 200° C., | Change |
| | C | D | PS | ABS | PS-B | PS-C | PS-D | 5 kg | in MFI |
| Control II | 0 | 0 | 100 | 0 | 0 | 0 | 0 | 1.98 | — |
| 58 | 0 | 2 | 98 | 0 | 0 | 0 | 0 | 2.17 | 9.60 |
| 59 | 0 | 4 | 96 | 0 | 0 | 0 | 0 | 2.71 | 36.87 |
| 60 | 0 | 6 | 94 | 0 | 0 | 0 | 0 | 3.11 | 57.07 |
| 61 | 0 | 8 | 92 | 0 | 0 | 0 | 0 | 3.48 | 75.76 |
| 62 | 0 | 10 | 90 | 0 | 0 | 0 | 0 | 6.04 | 205.05 |
| Control III | 0 | 0 | 0 | 0 | 100 | 0 | 0 | 8.75 | — |
| 63 | 0 | 2 | 0 | 0 | 98 | 0 | 0 | 12.51 | 42.97 |
| 64 | 0 | 4 | 0 | 0 | 96 | 0 | 0 | 11.86 | 35.54 |
| 65 | 0 | 6 | 0 | 0 | 94 | 0 | 0 | 15.07 | 72.23 |
| 66 | 0 | 8 | 0 | 0 | 92 | 0 | 0 | 15.94 | 82.17 |
| 67 | 0 | 10 | 0 | 0 | 90 | 0 | 0 | 18.12 | 107.09 |
| Control IV | 0 | 0 | 0 | 0 | 0 | 100 | 0 | 5.6535 | — |
| 68 | 2 | 0 | 0 | 0 | 0 | 98 | 0 | 6.533 | 15.56 |
| 69 | 4 | 0 | 0 | 0 | 0 | 96 | 0 | 6.814 | 20.53 |
| 70 | 8 | 0 | 0 | 0 | 0 | 92 | 0 | 7.983 | 41.20 |
| 71 | 10 | 0 | 0 | 0 | 0 | 90 | 0 | 9.276 | 64.08 |
| 72 | 15 | 0 | 0 | 0 | 0 | 85 | 0 | 9.893 | 74.99 |
| Control V | 0 | 0 | 0 | 0 | 0 | 75 | 25 | 5.448 | — |
| 73 | 2 | 0 | 0 | 0 | 0 | 73 | 25 | 5.969 | 9.56 |
| 74 | 4 | 0 | 0 | 0 | 0 | 71 | 25 | 6.927 | 27.15 |
| 75 | 8 | 0 | 0 | 0 | 0 | 67 | 25 | 7.502 | 37.70 |
| Control VI | 0 | 0 | 0 | 100 | 0 | 0 | 0 | 2.761 | — |
| 76 | 2 | 0 | 0 | 98 | 0 | 0 | 0 | 2.618 | −5.18 |
| 77 | 4 | 0 | 0 | 96 | 0 | 0 | 0 | 3.280 | 18.8 |
| 78 | 8 | 0 | 0 | 92 | 0 | 0 | 0 | 3.757 | 36.07 |
| 79 | 10 | 0 | 0 | 90 | 0 | 0 | 0 | 3.786 | 37.12 |
| 80 | 15 | 0 | 0 | 85 | 0 | 0 | 0 | 5.896 | 113.55 |

Control II served as a control for Formulations 58-62; Control III served as a control for Formulations 63-67; Control IV served as a control for Formulations 68-72; Control V served as a control for Formulations 73-75; and Control VI served as a control for Formulations 76-80.

As indicated in Table 7, as the percentage of styrenic polymer increased, the resulting melt flow index of both virgin and recycled polystyrene feedstock increased.

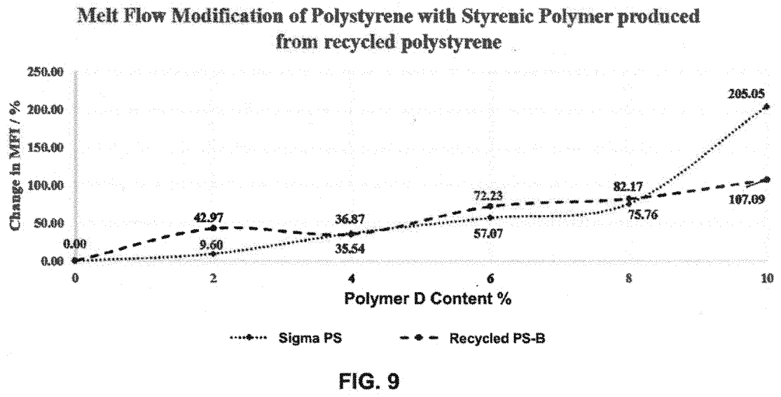

FIG. 9 is a graph illustrating the percent change in melt flow index of resin blends Control II, Control III and Formulations 58-67.

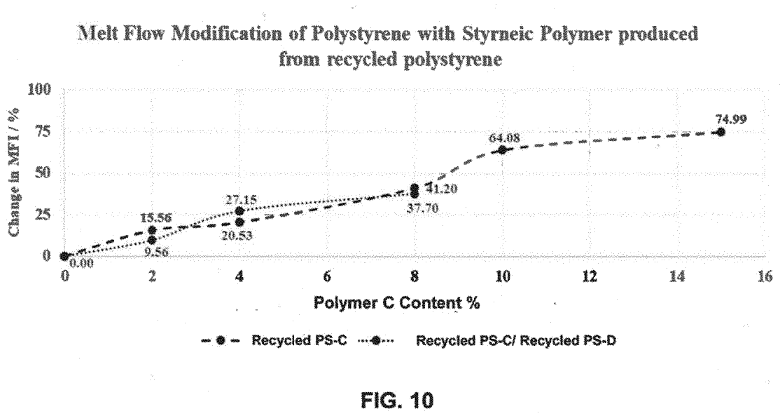

FIG. 10 is a graph illustrating the percent change in melt flow index of resin blends Control IV, Control V and Formulations 68-75.

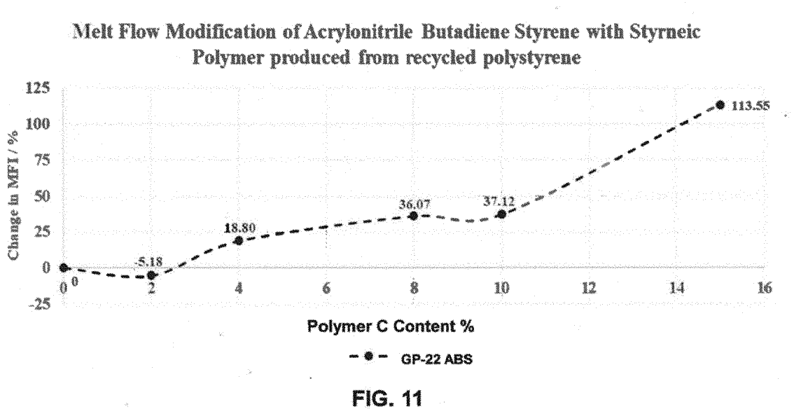

FIG. 11 is a graph illustrating the percent change in melt flow index of resin blends Control VI and Formulations 76-80.

These data indicate low molecular weight fractions of styrenic polymers can be used to increase the melt flow of both virgin and recycled polystyrene and ABS. Increasing the melt flow of recycled polystyrene can confer its ability to be used in applications such as, but not limited to, synthetic resin formulations, foam resin formulations, and formulations for rigid polystyrene and ABS products.

Collectively, these data indicate styrenic polymers derived from depolymerization of waste polystyrene have unique properties that are advantageous for use in synthetic resin formulations. These unique properties are conferred during the depolymerization process and include, at least, a narrower distribution of molecular weight and melt flow compared to that of unmodified recycled/waste polystyrene.

While particular elements, embodiments and applications of the present invention have been shown and described, it will be understood, that the invention is not limited thereto since modifications can be made without departing from the scope of the present disclosure, particularly in light of the foregoing teachings. Further, all of the claims are hereby incorporated by reference into the description of the preferred embodiments.

What is claimed is:

1. A synthetic resin formulation comprising a styrenic polymer created via depolymerization of a polystyrene feedstock.

2. The synthetic resin formulation of claim 1, wherein said styrenic polymer has a molecular weight between and inclusive of 5,000-150,000 amu.

3. The synthetic resin formulation of claim 2, wherein said styrenic polymer has a melt flow index between and inclusive of 25-1,000 g/min.

4. The synthetic resin formulation of claim 2, wherein said styrenic polymer increases the amount of a recycled polystyrene that can be used in said synthetic resin formulation by increasing and homogenizing the melt flow of said recycled polystyrene.

5. The synthetic resin formulation of claim 2, wherein said styrenic polymer increases the melt flow of PS and/or ABS plastic.

6. The synthetic resin formulation of claim 2, wherein said styrenic polymer increases throughput for extrusion of PS and/or ABS plastic.

7. The synthetic resin formulation of claim 2, wherein said styrenic polymer is 0.5-20% by weight of said synthetic resin formulation.

8. The synthetic resin formulation of claim 2, wherein said styrenic polymer is at least 20% by weight of said synthetic resin formulation.

9. A polystyrene foam product comprising the synthetic resin formulation of claim 1.

10. The polystyrene foam product of claim 9, wherein said polystyrene foam product is an extruded polystyrene foam product.

11. The polystyrene foam product of claim 9, wherein said polystyrene foam product is packing material.

12. The polystyrene foam product of claim 9, wherein said polystyrene foam product is an expanded polystyrene foam product.

13. The polystyrene foam product of claim 9, wherein said polystyrene foam product is a graphite polystyrene foam product.

14. The polystyrene foam product of claim 10, wherein said extruded polystyrene foam product is insulation.

15. The synthetic resin formulation of claim 1, wherein said styrenic polymer has a molecular weight between and inclusive of 150,000-230,000 amu.

16. The synthetic resin formulation of claim 15, wherein said styrenic polymer has a melt flow index between and inclusive of 1-25 g/10 min.

17. The synthetic resin formulation of claim 1, wherein said styrenic polymer reduces the amount of a virgin polystyrene needed for said synthetic resin formulation.

18. The synthetic resin formulation of claim 1, wherein said synthetic resin formulation is used to make an injection molded or extruded ABS product.

19. A rigid polystyrene product comprising the synthetic resin formulation of claim 1.

20. The rigid polystyrene product of claim 19, wherein said ridged polystyrene product is a container.
